(19) United States
(12) Patent Application Publication
(10) Pub. No.: US 2013/0022068 A2
(43) Pub. Date: Jan. 24, 2013

(54) Laser System Provided With a Frequency Servo

(71) Applicants: Fabien KEFELIAN, Paris (FR); Haifeng JIANG, Creteil (FR); Pierre LEMONDE, Paris (FR); Giorgio SANTARELLI, Gagny (FR)

(72) Inventors: Fabien KEFELIAN, Paris (FR); Haifeng JIANG, Creteil (FR); Pierre LEMONDE, Paris (FR); Giorgio SANTARELLI, Gagny (FR)

(73) Assignees: Observatoire de Paris, Paris (FR); Centre National de la Recherche Scientifique, Paris (FR); Universite Pierre et Marie Curie, Paris 6, Paris (FR)

(21) Appl. No.: 13/141,940

(22) PCT Filed: Dec. 3, 2009
(86) PCT No.: PCT/EP2009/066338

§ 371 Date: Sep. 9, 2011

(30) Foreign Application Priority Data
Dec. 23, 2008 (FR) 08/59014

(51) Int. Cl. H01S 3/10

(52) U.S. Cl. 372/38.02

(57) ABSTRACT

The invention relates to a laser system provided with a laser radiation device (1) in which the radiation frequency is controlled by a heterodyne servo circuit particularly using an interferometric circuit (15). Said interferometric circuit comprises a coil of optical fibres (17) which provide a reference for correcting the laser radiation frequency. To obtain good results in the field of spectral purity, all the elements involved in the laser radiation are fibres and the connections thereof are provided by optical fibres. The invention can be used for lasers requiring high spectral purity.

### BACKGROUND OF THE INVENTION

This invention relates to a laser system equipped with a laser radiation device provided with a frequency control and a servo circuit for the frequency of said radiation, which servo circuit comprises:
a heterodyne-type interferometric circuit equipped with an inlet for receiving said radiation, an interference outlet, at least two arms of which one is referred to as short arm and the other is referred to as the long arm and a frequency modulation device arranged in one of the arms,
a modulation generator for providing a modulation signal to the modulation device,
a photodetector circuit connected to said interference outlet,
an error detector circuit for providing an error signal, receiving on one side a signal referred to as local coming from the modulation generator and on the other side, the signal referred to as heterodyne provided by said photodetector circuit,
a filtering circuit for providing, on the basis of the signals coming from the error detection circuit, first correction signals.

Laser systems with low-frequency noise have many applications in numerous fields, such as oil exploration in which they are a basic element of the seismic detector, range finding, and so on.

Such a laser system is described in the article “High-bandwidth laser frequency stabilization to a fiber-optic delay line” by Benjamin S. Sheard et al, published on Nov. 20, 2006 in the journal APPLIED OPTICS (Vol. 45, No. 33).

### BRIEF SUMMARY OF THE INVENTION

The invention proposes a system of the type mentioned in the introduction, which provides laser radiation with good performance and in particular reduced frequency noise.

According to the invention, the device according to the introduction is notable in that all of the elements involved in the laser radiation are of the fiber type, in particular the laser device, the interferometric circuit, the frequency modification circuit, the photo-detector circuit and in that optical fibers are provided to ensure all of the connections between these elements.

The applicant realized that this feature makes implementation very simple and renders the system very robust due to the absence of any necessary adjustment concerning the alignment of the optical elements, while enabling very significant stabilization of the optical frequency to be obtained.

According to another embodiment, a laser system is notable in that the servo system comprises a module for controlling the phase variation between the “local” signal and the as “heterodyne” signal so as to vary, in a determined manner, the frequency of the laser radiation to be provided for use. This embodiment provides advantage of making it possible to vary, in a servo manner, the frequency of the laser radiation in particular digitally.

### BRIEF DESCRIPTION OF THE DRAWINGS

The following description, accompanied by the appended drawings, provided as a non-limiting example, will make it easier to understand how the invention can be implemented. In the drawings:

FIG. 1 shows a laser device according to the invention,

FIG. 2 shows a Michelson interferometric circuit,

FIG. 3 shows a Mach-Zehnder interferometric circuit,

FIG. 4 shows an alternative embodiment of a laser system with a digital frequency control,

FIG. 5 shows a comparative table of the results obtained by the measures recommended by the invention in comparison with known laser systems.

In these figures, the same elements are denoted by the same reference signs.

### DETAILED DESCRIPTION OF THE INVENTION

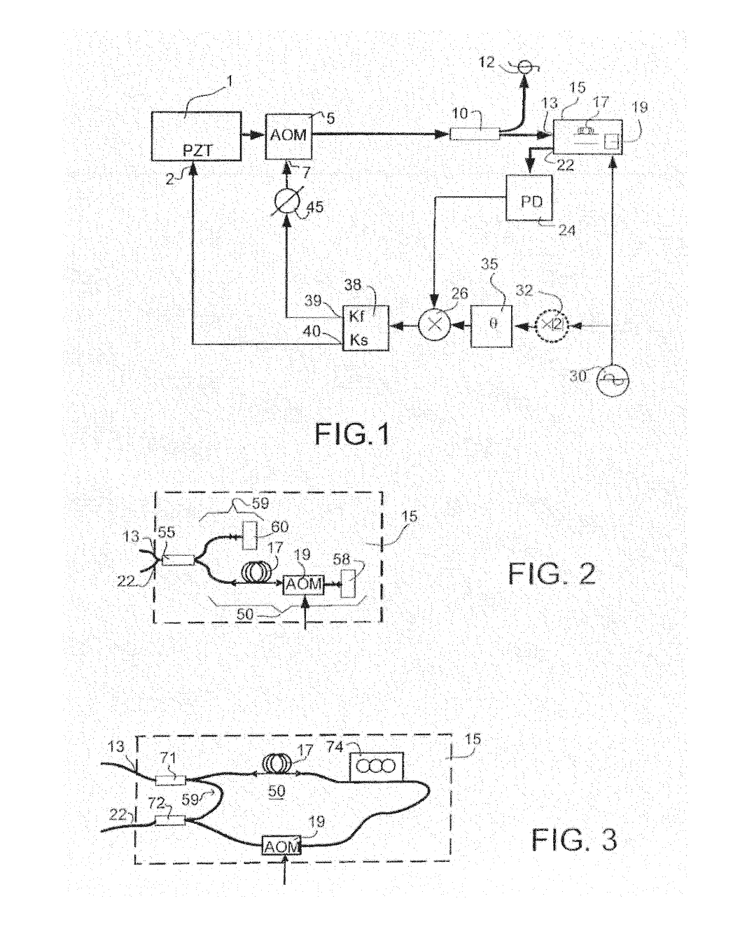

In FIG. 1, reference 1 indicates an optical signal laser source. This device is equipped with a frequency control 2 that acts, for example, on a piezoelectric element coupled to the cavity of said laser source 1 thus causing its frequency to vary over a wide range. The outlet of the laser 1 is connected to an acousto-optical modulator 5 equipped with a modulation inlet 7. The outlet of this modulator is connected to the inlet of an optical coupler 10, which provides, at the outlet 12, the low-frequency noise optical signal and samples a portion of it to apply it to the inlet 13 of an interferometer 15 with a frequency offset. This interferometer 15 comprises, inter alia, a short arm and a long arm comprising a very long (˜1 km) fiber optic coil 17 and an acousto-optical modulation device 19 producing a frequency offset of the signal. The frequency shifter 19 can also be placed in the short arm. This interferometer is suitably protected from environmental mechanical, acoustic and thermal disturbances according to methods available to a person skilled in the art.

At the outlet of the interferometer 15, called the interference outlet 22, the overlapping of optical waves from the short and long arms forming the optical interferometric signal is collected. This interferometric signal is sent to a photodetector 24. The photodetector provides a radiofrequency signal of which the phase is modulated by a signal proportional to the frequency noise of the laser measured by reference to the length of the fiber 17. This modulated RF signal is demodulated by means of a mixer circuit 26, which is connected to the oscillator 30 controlling the modulator 19. Before being applied to the mixer 26, the frequency of the signal coming from the local oscillator 30 can be modified so as to take into account the interferometric circuit 15. Thus, for a Michelson interferometric circuit, the output frequency needs to be multiplied by 2 by means of a multiplier 32. If it is a Mach-Zehnder interferometric circuit, this multiplier is not inserted. It is important to note that the electrical cables induce a phase shift θ between the local signal and the heterodyne signal. This phase shift θ is represented by the box 35 in FIG. 1. If the modulator 19 is an acousto-optical modulator or an electro-optical modulator with a single sideband, the frequency of the servo laser (12) varies with this phase shift, a notable property that will subsequently be exploited.

According to the invention, the laser system is of the fiber type, i.e. all of the elements, in particular the interferometric circuit, involved in the transmission of the radiation, are of the fiber type. That is to say that they are equipped with connectors for optical fibers and are therefore connected to one another by optical fibers. The optical fibers can be of the following types: standard single-mode fiber, polarization maintaining fiber, polarizing fiber and photonic crystal fiber.

According to another aspect of the invention, the output signal of the mixer 26 is applied to a servo loop filter 38 that provides, respectively on two of its outputs 39 and 40, an error signal filtered according to two time constants Kf and Ks. The time constant Kf corresponds to a fast fluctuation in the error signal and the time constant Ks corresponds to a slow fluctuation of this error signal. The error signal filtered at the output 40 is applied to the control 2 acting on the frequency of the laser and the error signal at the output 39 is applied to the frequency variation control of an oscillator with voltage control 45 of which the output frequency may vary rapidly within a range of about 1 MHz, for example. The output signal of this oscillator is applied to the modulation inlet 7 of the modulator 5, which therefore enables a fast correction of the frequency of the optical signal leaving through channel 12. It is possible to use different interferometric circuits, of which two non-limiting examples are provided below. Other types may be suitable for the implementation of the invention.

According to a first example, the interferometric circuit (15), shown in detail in FIG. 2, is a Michelson interferometer. It consists, first, of the fiber optic coil 17, which is inserted in the long arm 50 of said interferometer between an inlet of a coupler 55 and a Faraday mirror 58. Another inlet of the coupler 55 is connected to the short arm 59, which consists essentially of a Faraday mirror 60. The modulator 19 can be inserted into the long or the short arm. Two other inlets of the coupler form, respectively, the inlet 13 of the interferometer and the interference outlet 22. The choice of Faraday mirrors 58 and 60 ensures perfect alignment of the polarizations of the two optical fields at the outlet 22 so as to obtain an optimal beat signal.

According to a second example, the interferometric circuit, shown in detail in FIG. 3, is a Mach-Zehnder interferometer, which can be used by the invention. The long arm 50 and the short arm 59 are connected, respectively, to two coupler inlets 71 and 72, and their outlets are connected to two other inlets of these couplers 71 and 72. The long arm 50 is formed by a fiber coil 17 of a polarization orientation device 74 so as to align the polarizations of the waves coming from the two arms at the inlet of the coupler 72 and an acousto-optical modulator 19. The short arm is produced by directly connecting the fiber ends of the couplers 71 and 72. The acousto-optical modulator 19 and/or the polarization controller 74 can also be placed in the short arm 59.

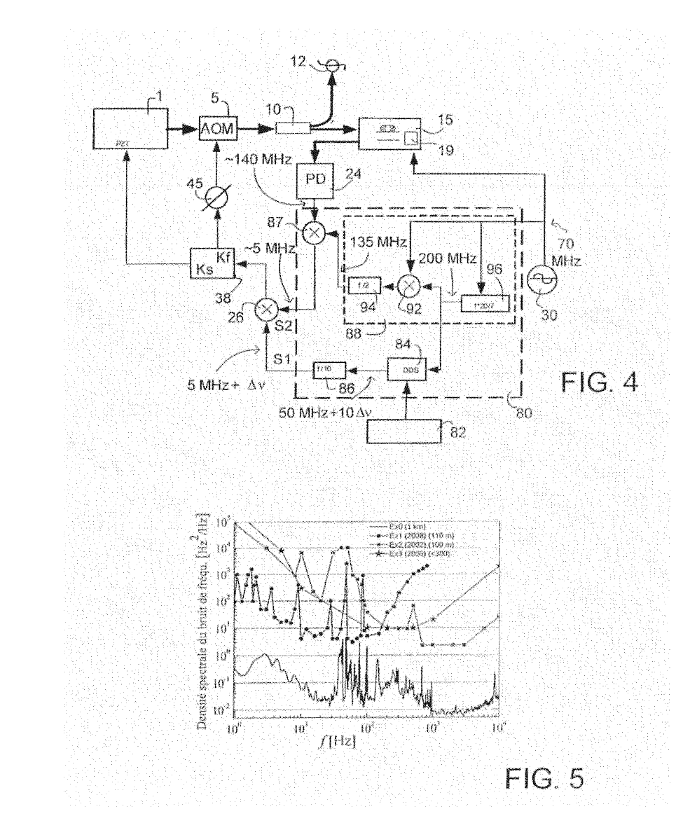

FIG. 4 shows another alternative embodiment of the system for reducing the frequency noise of a laser, making it possible to control the mean frequency of the low-frequency noise optical signal provided at the outlet 12. This alternative is based on the dynamic control of the phase shift θ, already mentioned, existing between the heterodyne signal and the local signal applied at the two ports of the mixer 26. The phase variation Δθ induces a variation Δθ/2πτ in the mean frequency of the optical signal provided at the output 12, in which τ is the delay induced by the fiber 17. According to this alternative, a frequency servo control module denoted by reference 80, controlled, for example, by means of a computer 82 via a digital interface, has been inserted. To control the phase shift θ, this module introduces a controlled frequency offset between the local signal S1 and the heterodyne signal S2 at the mixer 26 acting as an error detector. The value of the frequency offset can be defined by means of the digital interface and has a very low noise due to the use of a DDS circuit denoted by reference 84, synchronized on the oscillator 30 common to the signal S2 and the signal S1. It is also possible to use a low-noise voltage-controlled oscillator. The frequency of the output signal of the circuit 84 can be adjusted by a frequency divider 86. This frequency offset induces a phase variation Δθ/second=2πΔν, which induces one variation per second in the mean frequency of the optical signal at the output 12 of Δν/τ.

To make these concepts more concrete, FIG. 4 shows an example of an embodiment of such a module. This example in no case limits the scope of the invention. In this example, the heterodyne signal provided by the photodetector 24 is converted at an intermediate carrier frequency of 5 MHz by mixing on a mixer 87 with a signal at 135 MHz coming from the oscillator 30 by a low-noise frequency synthesis circuit 88 including a mixer 92 and frequency multiplier and divider circuits 94 and 96. The local signal S1 is generated by means of the direct digital synthesis (DDS) circuit 84, for example, the registered circuit AD9852 synchronized on the oscillator 30 via the low-noise 100 frequency synthesis circuit 88 converting the signal at 70 MHz coming from the oscillator 30 into a clock signal at 200 MHz. The DDS circuit, followed by the frequency divider by ten 86, generates the local signal at the input of S1 with a frequency 5 MHZ+Δν.

In FIG. 5, the different performances of known systems were compared with the system of the present invention.

The curve Ex0 is the one provided by the system according to the invention.

The curve Ex1 corresponds to the system described in the article entitled “Stabilization of Laser Intensity and Frequency Using Optical Fiber” by Kakeru Takahashi, Masaki Ando and Kimio Tsubono, published in the Journal of Physics: Conference Series 122 (2008) 012016.

The curve Ex2 corresponds to the system described in the article entitled “Frequency noise reduction in erbium-doped fiber distributed-feedback lasers by electronic feedback” by G. A. Cranch, published in the journal OPTICS LETTERS/Vol. 27, No. 13/Jul. 1, 2002.

The curve Ex3 corresponds to the system described in the article entitled “Ultra-Narrow Linewidth and High Frequency Stability Laser Sources” in Optical Amplifiers and Their Applications/Coherent by J. Cliche, M. Allard and M. Tetu, published in Optical Technologies and Applications, Technical Digest (CD) (Optical Society of America, 2006), paper CFC5.

1. A laser system provided with a laser radiation device equipped with a frequency control and a servo circuit for the frequency of said radiation, which servo circuit comprises:
a heterodyne-type interferometric circuit equipped with an inlet for receiving said radiation, an interference outlet, at least two arms of which one is referred to as short arm and the other is referred to as long arm and a frequency modulation device arranged in one of the arms,
a modulation generator for providing a modulation signal to the modulation device,
a photodetector circuit connected to said interference outlet,
an error detector circuit for providing an error signal, receiving on one side a signal referred to as local coming from the modulation generator and on the other side, the signal referred to as heterodyne provided by said photodetector circuit,
a filtering circuit for providing, on the basis of the signals coming from the error detection circuit, first correction signals,
wherein all of the elements involved in the laser radiation are of the fiber type, in particular the laser device, the interferometric circuit, the frequency modification circuit, the photo-detector circuit and wherein optical fibers are provided to ensure all of the connections between these elements.

2. The laser system according to claim 1, characterized in that the servo circuit comprises a frequency modification circuit for modifying the frequency of said radiation provided by said laser radiation device by a signal applied at its modification inlet,
the filtering circuit also provides second correction signals referred to as fast,
the frequency modification circuit is controlled by means of a variable frequency oscillator of which the outlet is connected to said modification inlet and of which the frequency control inlet receives said fast correction signals.

3. The laser system according to claim 1, characterized in that the interferometric circuit is of the Michelson type.

4. The laser system according to claim 1, characterized in that the interferometric circuit is of the Mach-Zehnder type.

5. The laser system according to a claim 1, characterized in that the servo system comprises a control module for varying, in a determined manner, the frequency of the laser radiation by acting on the phase difference between the local signal and the heterodyne signal entering through the two ports of the mixer 26.

6. The laser system according to claim 5, characterized in that said frequency variation control module is formed by a frequency-controllable signal generator so as to introduce a small low-noise frequency difference between the local signal applied at the inlet S1 of the mixer and the heterodyne signal S2.

7. The laser system according to claim 6, characterized in that the signal coming from the photodetector is converted at an intermediate frequency by a frequency synthesis circuit by means of the oscillator so as to reduce the noise of the source used to provide the local signal S1.

8. The laser system according to claim 7 characterized in that said frequency-controllable signal generator is a circuit known as a DDS digital signal synthesis circuit.
